(19) United States
(12) Patent Application Publication
(10) Pub. No.: US 2003/0123684 A1
(43) Pub. Date: Jul. 3, 2003

(54) Three-way speaker system having translatable midrange/tweeter module

(76) Inventors: Raymond Lee Call II, Mission Viejo, CA (US); Todd Patrick Ryan, San Clemente, CA (US)

Correspondence Address: STETINA BRUNDA GARRED & BRUCKER, 75 ENTERPRISE, SUITE 250, ALISO VIEJO, CA, 92656, US

(21) Appl. No.: 10/038,492

(22) Filed: Jan. 2, 2002

(51) Int. Cl. H04R 25/00

(52) U.S. Cl. 381/182

(57) ABSTRACT

A three-way speaker system is provided having a translatable midrange/tweeter module. The system comprises a speaker frame having a central speaker axis, and a bass speaker secured to the speaker frame and centered on the speaker axis. A cylindrical compression module is disposed along the speaker axis, having a first end engaged to the bass speaker and a second end resiliently extending therefrom. A midrange/tweeter module is centered on a speaker axis in compressive engagement with a compression member. A yoke is secured to the speaker frame, having a annular support member for receiving and maintaining the midrange/tweeter module in compressive engagement with the compression member, while permitting axial translation of the midrange/tweeter module.

### STATEMENT RE: FEDERALLY SPONSORED RESEARCH/DEVELOPMENT

(Not Applicable)

### CROSS-REFERENCE TO RELATED APPLICATIONS

(Not Applicable)

### BACKGROUND OF THE INVENTION

The present invention relates to in-wall and in-ceiling type speaker systems and, more particularly, to three-way speaker systems having adjustable speaker components.

In-wall speaker systems have evolved from crude intercom systems to the more high fidelity systems currently available today. Such speaker systems are adapted for flush mounting in walls or ceilings, and may be supported in various ways. In some cases the speaker systems are installed during the initial construction of a structure, and may be secured to beams or other structural members within a wall or ceiling. In other cases such speaker systems may be retrofit to existing walls or ceilings, whereupon they may utilize different types of mechanisms for maintaining their position in a wall or ceiling.

Despite the flexibility of current in-wall speaker systems, there are circumstances where their installation location may be limited by structural members, electrical wiring, or other circumstances that may preclude locating a speaker in the most desirable position in relation to the listening audience. In such circumstances it is desirable to be able to translate speaker portions, so that they may be aimed more specifically to the prime listening area. Such translation is particularly significant in relation to mid-frequency and high-frequency speakers, which are more sensitive to directional orientation. As such, there is a need for a simple, reliable three-way speaker system that permits adjustment of mid-frequency and high-frequency speaker orientations in order to optimize acoustical conditions in the listening area. It is particularly desirable to achieve such functionality without undo mitigation upon the performance of each speaker within the three speaker system. The present invention is directed to an apparatus for achieving these and other functions in a high quality, in-wall speaker system.

### BRIEF SUMMARY OF THE INVENTION

A three-way speaker system is provided having a translatable midrange/tweeter module. The system comprises a speaker frame having a central speaker axis, and a bass speaker secured to the speaker frame and centered on the speaker axis. A cylindrical compression module is disposed along the speaker axis, having a first end engaged to the bass speaker and a second end resiliently extending therefrom. A midrange/tweeter module is centered on the speaker axis in compressive engagement with a compression member. A yoke is secured to the speaker frame, having a annular support member for receiving and maintaining the midrange/tweeter module in compressive engagement with the compression member, while permitting axial translation of the midrange/tweeter module.

The speaker frame may be formed to define a cylindrical outer surface adapted for flush mounting on a wall or ceiling. The cylindrical compression member may be formed to have a slotted outer surface for rotationally fixed engagement to the bass speaker. The compression member may also be formed to include a cylindrical base, a spring member disposed within the base, and a load member engageable to the spring and axially translatable with respect to the base.

The midrange/tweeter speaker module may be formed to include a midrange/tweeter speaker set and a housing, engaged to and supporting the speaker set. The midrange and tweeter speakers may be arrayed in relative stationary position, to thereby move as a set.

In one embodiment the speaker set housing may be formed to define a concave rear surface portion for abutting engagement to the compression member. The housing may also define curved sidewalls to facilitate sliding engagement within the yoke.

The yoke annular support member may similarly have curved inner sidewalls for sliding engagement with the midrange/tweeter module. The sidewalls may have a first end defining an aperture having a diameter less than the housing sidewalls diameter, and a second end defining an aperture having a diameter greater than the housing sidewalls diameter.

### BRIEF DESCRIPTION OF THE DRAWINGS

The features of the present invention will become more apparent upon reference to the drawings wherein:

FIG. 1 is a front view of a three-way speaker system in accordance with the present invention;

FIG. 2 is an exploded view of the speaker system shown in FIG. 1;

FIG. 3 is a rear perspective view of a midrange tweeter module;

FIG. 4 is an exploded view illustrating the midrange tweeter module separated from the speaker frame and bass speaker;

FIG. 5 is a cross-sectional view of the midrange speaker module;

FIG. 6 is a perspective view of the compression member;

FIG. 7 is a exploded view of the compression member; and

FIG. 8 is a cross-sectional view of the compression member.

### DETAILED DESCRIPTION OF THE INVENTION

The present invention is described below in connection with the illustrated embodiments. However, it is to be understood that the embodiments shown are exemplary and may be modified to accommodate different structures and functionalities without departing from the broader aspects of the invention as described herein.

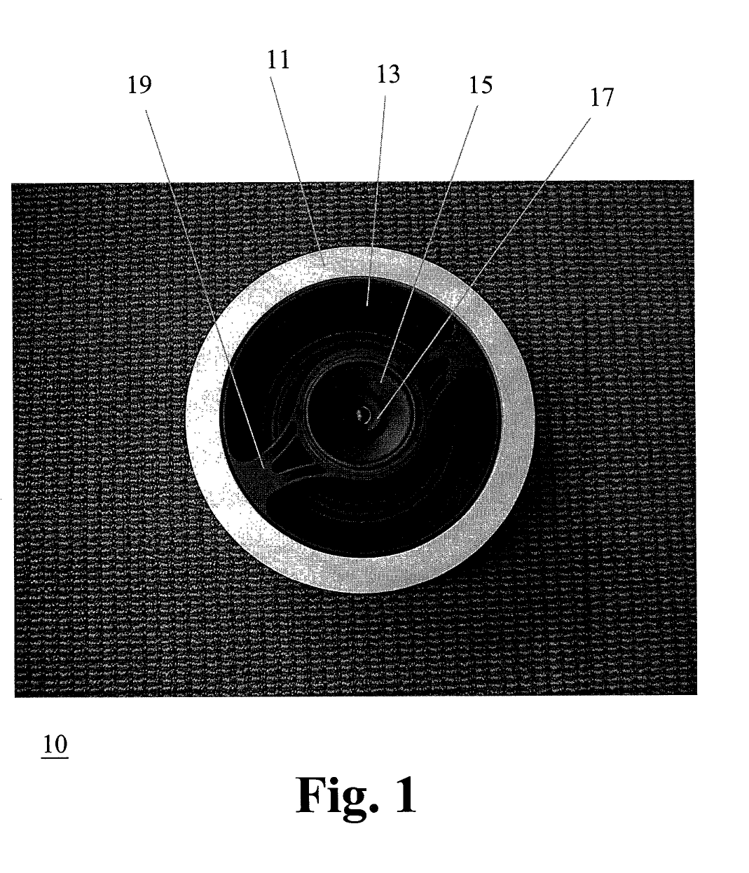

FIG. 1 illustrates a front view of a three-way speaker system 10 formed in accordance with the present invention. As shown therein, the speaker system 10 incorporates a speaker frame or baffle 11, within which three speakers are disposed. The lower most speaker is a bass speaker 13. Above bass speaker 13 rests midrange speaker 15 and tweeter 17. As described in more detail below, the midrange and tweeter speakers 15, 17 are both engaged to a midrange/tweeter module 23, which is supported within the speaker frame 11 by yoke 19 and compression member 21 (not shown at FIG. 1).

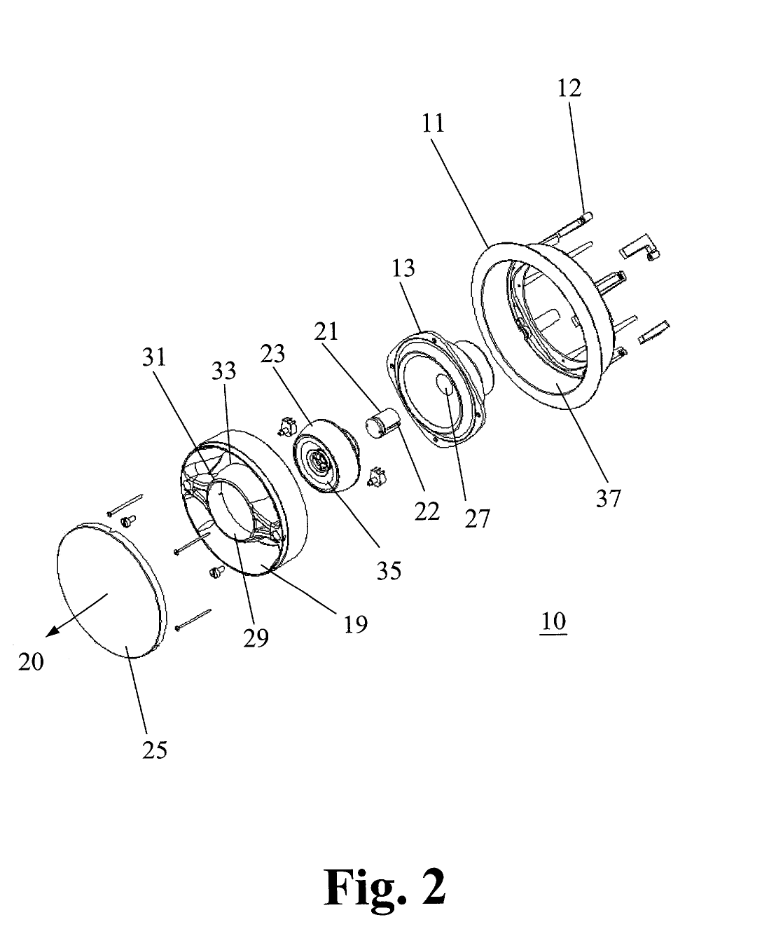

FIG. 2 provides an exploded view of the three-way speaker 10. As shown therein bass speaker 13 rests within and is secured to speaker frame 11. A compression member 21 extends axially within receiving aperture 27, formed in the center portion of bass speaker 13. As described in more detail below, compression member 21 urges against midrange/tweeter module 23, to maintain the module 23 in sliding engagement with the inner sidewall 29 of yoke 19. The inner sidewall 29 is curved to allow the module 23 to translate therewithin. The sidewall 29 defines a first end 31 having a diameter that is smaller than the diameter of module 23 at its largest point. The second end 33 of sidewall 29 has a diameter that is typically larger than the diameter of module 23 at its largest point. It should be understood, however, that the relative diameters of curved sidewall 29 and the outer wall of module 23 may be modified relative to each other as long as they cooperate to facilitate sliding translation of the module 23 to direct sound from the speaker/tweeter set 35 in the desired direction. Grill 25 rests on top of the speaker assembly and fits within the inside surface 37 of speaker frame 11. Securing dog 12 may be rotated to secure the speaker system 10 within a wall or ceiling surface such that the speaker system 10 remains in place and may be substantially flush to the wall or ceiling surface.

The compression member 21 may be provided with slots, such as longitudinal slot 22, engageable to a guide member within bass speaker aperture 27 to maintain the compression member 21 in a rotationally fixed engagement to bass speaker 13. As will be apparent from FIG. 2, the speaker frame 11, bass speaker 13, compression member 21, module 23, yoke 19 and grill 25 are all arrayed coaxially along a central speaker axis 20.

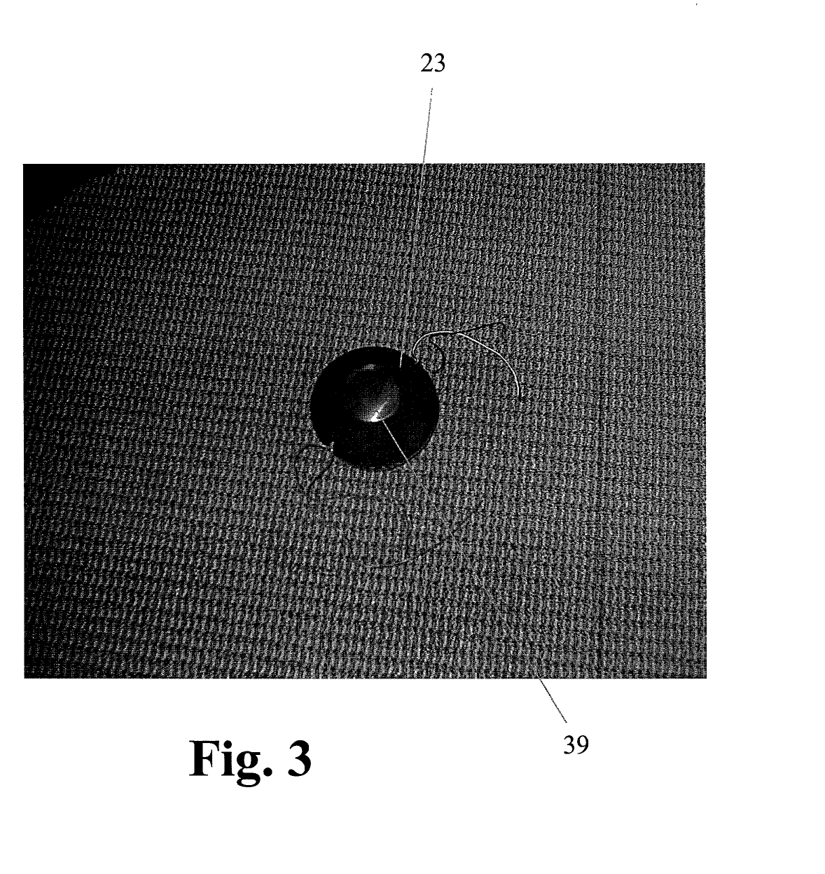

FIG. 3 illustrates a rear portion of midrange/tweeter module 23. As shown therein the module 23 may include a curved rear surface portion 39 for abutting engagement with compression member 21, to facilitate translation of the module 23.

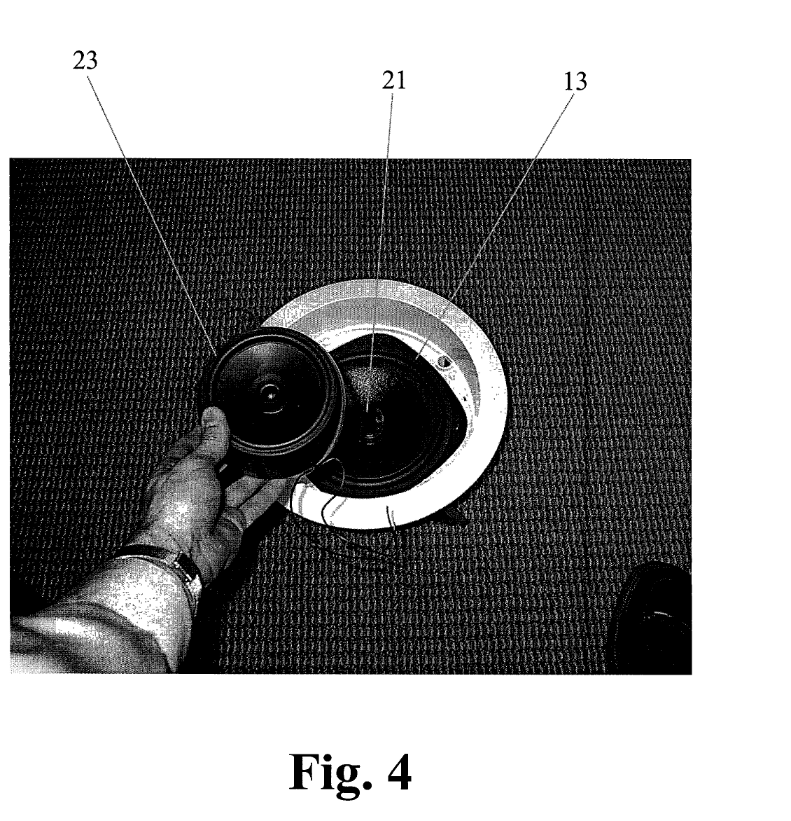

FIG. 4 illustrates the module 23 elevated from its resting position on compression member 21. As noted above, the compression member 21 has a portion extending within bass speaker 13.

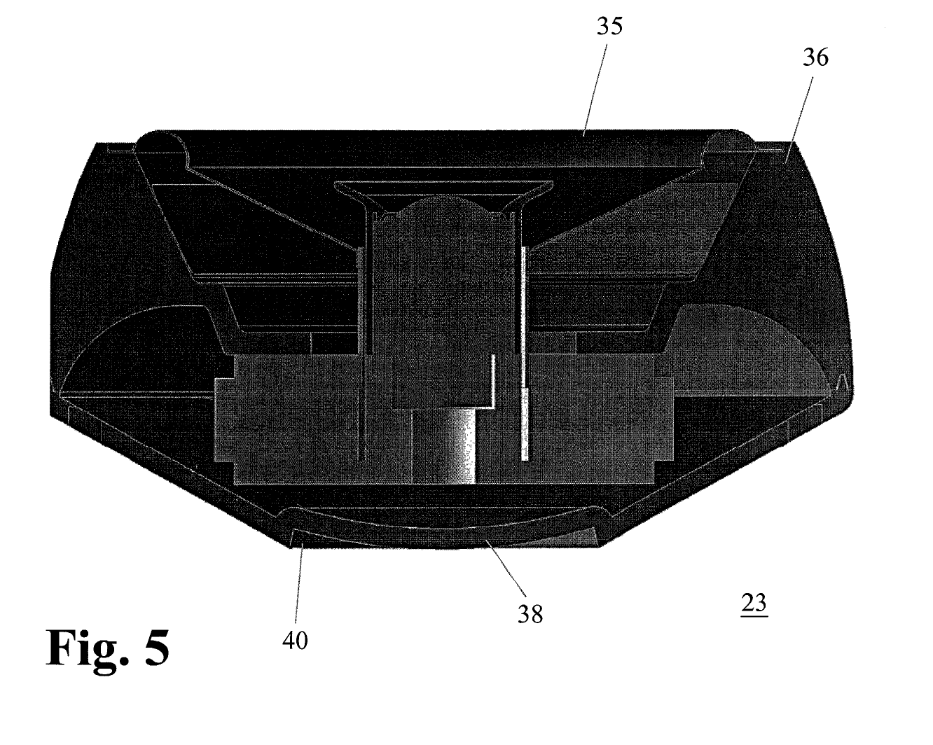

FIG. 5 presents a sectional view of the module 23. As shown therein the module includes a midrange/tweeter speaker set 35 disposed within and supported by housing 36. In the embodiment shown at FIG. 5 the rear surface of module 23 is formed to have a concave surface 38 formed within a lip 40. In this embodiment the compression member 21 is adapted to travel along the concave surface 38 within the area defined by lip 40.

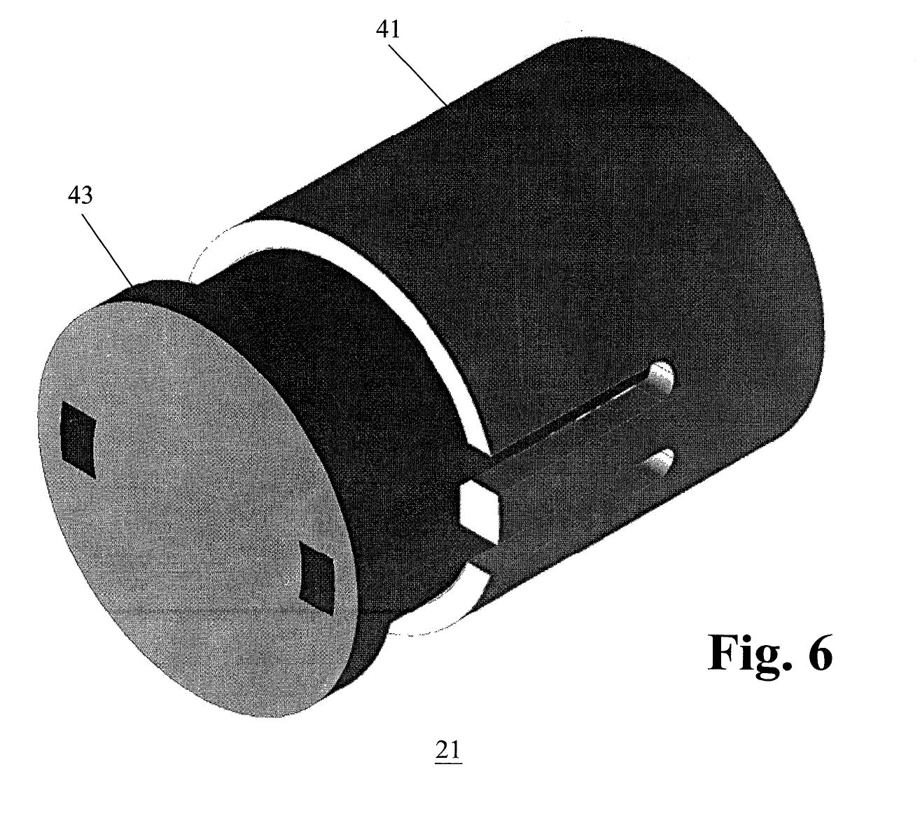

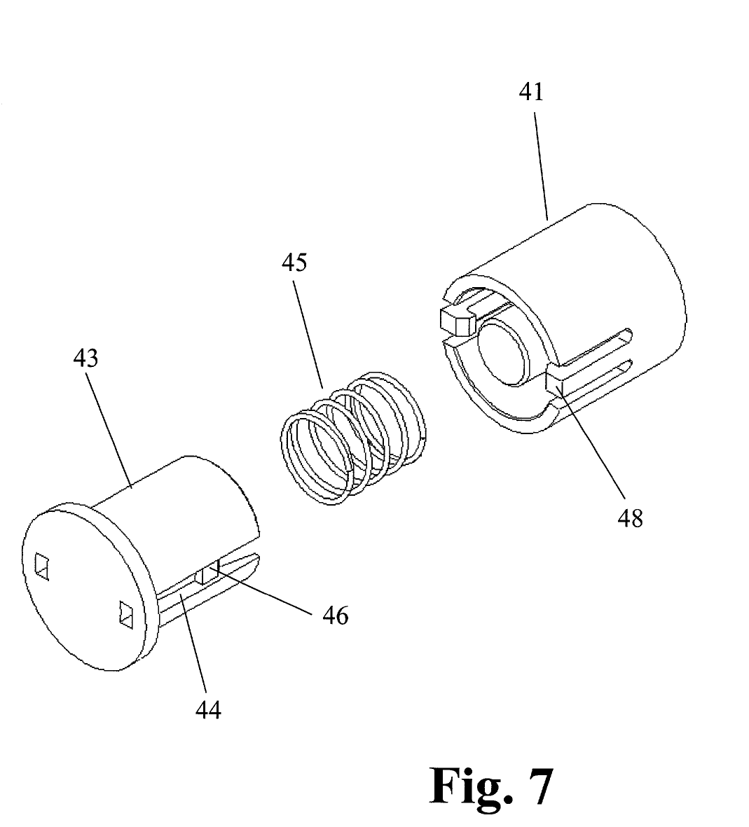

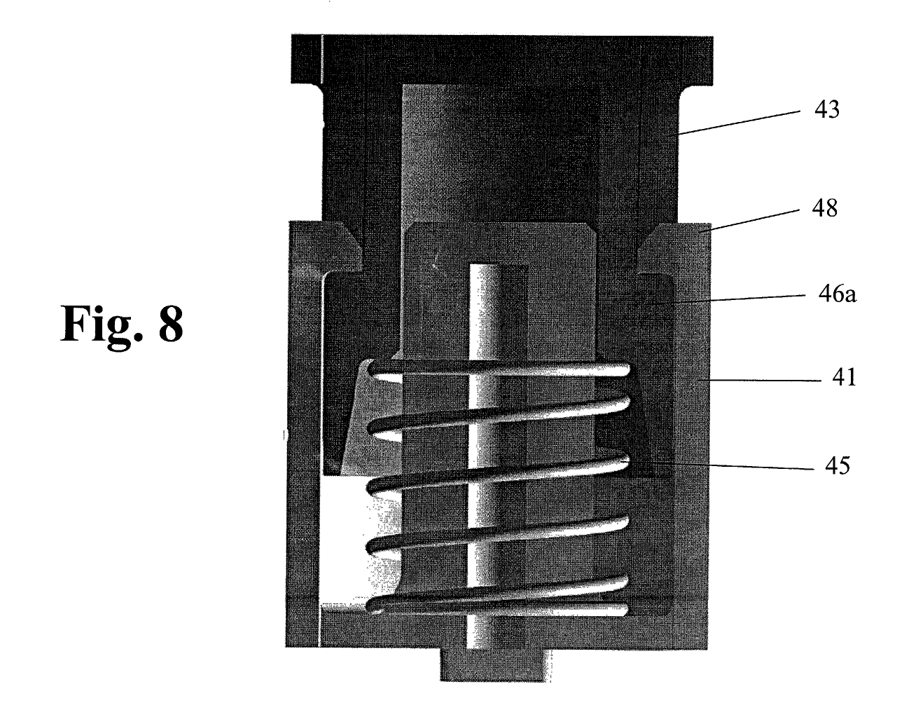

FIG. 6 is an enlarged view of one embodiment of the compression member 21. As shown therein the compression member 21 includes a cylindrical base 41 and load member 43. As shown in more detail at FIGS. 7 and 8, spring member 45 is disposed internal of the cylindrical base 41 and functions to urge load member 43 outwardly against the rear surface of midrange/tweeter module 23. Slots such as slot 44 may be formed within the load member 43, and provided with stop 46 to engage flange 48 to limit travel of the load member 43 in relation to the cylindrical base 41.

As shown at FIG. 8, the stop 46a may be alternately formed as may be more convenient to manufacture.

As will be apparent to one of ordinary skill, various additions and modifications of the three-way speaker system described herein can be modified without departing from the broader aspects of the invention.

1. A three-way speaker system having a translatable midrange/tweeter module, comprising:
(a) a speaker frame having a central speaker axis;
(b) a bass speaker, secured to the speaker frame and centered on the speaker axis;
(c) a cylindrical compression module disposed along the speaker axis, having a first end engaged to the bass speaker and a second end resiliently extending therefrom;
(d) a midrange/tweeter module centered on the speaker axis in compressive engagement with the compression module; and
(e) a yoke, secured to the speaker frame, having an annular support member for receiving and maintaining the midrange/tweeter module in compressive engagement with the compression module, while permitting axial translation of the midrange/tweeter module.

2. The system as recited in claim 1 wherein the speaker frame defines a cylindrical outer surface.

3. The system as recited in claim 1 wherein the compression module has a slotted outer surface for rotationally fixed engagement to the bass speaker.

4. The system as recited in claim 1 wherein the compression module comprises a cylindrical base, a spring member disposed within the base, and a cylindrical load member engageable to the spring member and axially translatable with respect to the base.

5. The system as recited in claim 1 wherein the midrange/tweeter module comprises a midrange/tweeter speaker set and a housing engaged to and supporting the speaker set.

6. The system as recited in claim 5 wherein the housing defines a concave rear surface portion for abutting engagement with the compression member.

7. The system as recited in claim 5 wherein the housing defines curved sidewalls for sliding engagement with the yoke.

8. The system as recited in claim 7 wherein the annular support member has curved inner sidewalls for sliding engagement with the midrange/tweeter module.

9. The system as recited in claim 8 wherein the annular support member has a first end defining an aperture having a diameter less than that of the housing sidewalls, and a second end defining an aperture having a diameter greater than that of the housing sidewalls.
